(19) United States
(12) Patent Application Publication
(10) Pub. No.: US 2025/0092821 A1
(43) Pub. Date: Mar. 20, 2025

(54) STATOR WITH ADJUSTABLE RADIAL HEIGHT

(71) Applicant: RTX Corporation, Farmington, CT (US)

(72) Inventors: Joon Won Ha, Glastonbury, CT (US); Bryce T. DeAlessio, Plainville, CT (US)

(21) Appl. No.: 18/467,837

(22) Filed: Sep. 15, 2023

(51) Int. Cl. F01D 9/04

(52) U.S. Cl. CPC F02C 3/02

(57) ABSTRACT

A stator assembly is provided and includes a stator element and a radial height adjustment mechanism. The stator assembly includes an inboard portion which establishes a primary clearance with rotor elements and exhibits a measurable parameter corresponding to the primary clearance and an outboard portion integrally formed with the inboard portion. The radial height adjustment mechanism is coupled with the outboard portion and configured to be operable, based on the measurable parameter, to adjust a radial height of the stator element and in turn to adjust the primary clearance.

### STATEMENT OF FEDERAL SUPPORT

This invention was made with Government support awarded by the United States. The Government has certain rights in this invention.

### BACKGROUND

Exemplary embodiments of the present disclosure relate generally to gas turbine engines and, in one embodiment, to a stator with adjustable radial heights.

In a gas turbine engine, air is compressed in a compressor and compressor air is then mixed with fuel and combusted in a combustor to produce a high-temperature and high-pressure working fluid. This working fluid is directed into a turbine in which the working fluid is expanded to generate power. The generated power drives the rotation of a rotor within the turbine through aerodynamic interactions between the working fluid and turbine blades or airfoils. The rotor can be used to drive rotations of a propeller or to produce electricity in a generator.

A stator is a component of the gas turbine engine that remains stationary while the rotor rotates about a rotational axis relative to the stator. In convention settings, multiple stators of different radial heights are needed for knife edge clearance tests. These tests require that the stators be repeatedly replaced by disassembly and reassembly of cases and mating parts. Such disassembling and reassembling of components during tests may cause significant noise in measurements.

Accordingly, a need exists for an improved stator that does not require component disassembly and reassembly for knife edge clearance tests.

### BRIEF DESCRIPTION

According to an aspect of the disclosure, a stator assembly is provided and includes a stator element and a radial height adjustment mechanism. The stator assembly includes an inboard portion which establishes a primary clearance with rotor elements and exhibits a measurable parameter corresponding to the primary clearance and an outboard portion integrally formed with the inboard portion. The radial height adjustment mechanism is coupled with the outboard portion and configured to be operable, based on the measurable parameter, to adjust a radial height of the stator element and in turn to adjust the primary clearance.

In accordance with additional or alternative embodiments, the measurable parameter is a capacitance.

In accordance with additional or alternative embodiments, the stator element further includes a body including an inner stator wall forming the inboard portion, an outer stator wall forming the outboard portion and stator vanes radially interposed between the inner stator wall and the outer stator wall.

In accordance with additional or alternative embodiments, the radial height adjustment mechanism includes a radial shaft affixed to the outboard portion and including a shoulder, a nut which is threadably engaged with the radial shaft whereby rotation of the nut adjusts a radial position of the stator element and the primary clearance and adjusts a secondary clearance and a shim to set the secondary clearance and in turn to set the radial position of the stator element and the primary clearance.

In accordance with additional or alternative embodiments, the radial height adjustment mechanism includes a radial shaft threadably engaged with the outboard portion and a nut which is affixed to the radial shaft whereby rotation of the nut rotates the radial shaft and radial shaft rotation securably adjusts a radial position of the stator element and the primary clearance.

In accordance with additional or alternative embodiments, the radial height adjustment mechanism includes an internal radial shaft that abuts with the outboard portion, an external radial shaft that surrounds the internal radial shaft and includes a shoulder and a first dovetail which is engagable with a second dovetail of the outboard portion, a nut which is threadably engaged with the external radial shaft whereby rotation of the nut causes engagement of the first and second dovetails to thereby adjust a radial position of the stator element and the primary clearance and adjusts a secondary clearance and a shim to set the secondary clearance and in turn to set the radial position of the stator element and the primary clearance.

In accordance with additional or alternative embodiments, the radial height adjustment mechanism includes a radial shaft affixed to the outboard portion, a bridge through which the radial shaft extends and a nut combination, which is threadably engaged with the radial shaft, whereby operation of the nut combination securably adjusts a radial position of the stator element relative to the bridge and the primary clearance.

According to an aspect of the disclosure, a turbine engine is provided and includes rotor elements and a case disposed about the rotor elements and including a stator assembly. The stator assembly includes a stator element and a radial height adjustment mechanism. The stator element includes an inboard portion which establishes a primary clearance with the rotor elements and exhibits a measurable parameter corresponding to the primary clearance and an outboard portion integrally formed with the inboard portion. The radial height adjustment mechanism is coupled with the outboard portion and configured to be operable, based on the measurable parameter, to adjust a radial height of the stator element and in turn to adjust the primary clearance between the inboard portion and the rotor elements.

In accordance with additional or alternative embodiments, the rotor elements include knife edges.

In accordance with additional or alternative embodiments, the measurable parameter is a capacitance of the inboard portion and the rotor elements across the primary clearance.

In accordance with additional or alternative embodiments, the stator element further includes a body having the inboard portion at an inboard side thereof and the outboard portion at an outboard side thereof.

In accordance with additional or alternative embodiments, the body includes an inner stator wall forming the inboard portion, an outer stator wall forming the outboard portion and which is disposable in close proximity to an internal wall of the case and stator vanes radially interposed between the inner stator wall and the outer stator wall.

In accordance with additional or alternative embodiments, the radial height adjustment mechanism includes a radial shaft affixed to the outboard portion and including a shoulder, a nut which is threadably engaged with a boss formed on the case and with the radial shaft whereby rotation of the nut adjusts a radial position of the stator element and the primary clearance and adjusts a secondary clearance between the shoulder and the boss and a shim interposable between the shoulder and the boss to set the secondary clearance and in turn to set the radial position of the stator element and the primary clearance.

In accordance with additional or alternative embodiments, the radial height adjustment mechanism includes a radial shaft threadably engaged with the outboard portion and a nut which is threadably engaged with a boss formed on the case and which is affixed to the radial shaft whereby rotation of the nut rotates the radial shaft and radial shaft rotation securably adjusts a radial position of the stator element and the primary clearance.

In accordance with additional or alternative embodiments, the radial height adjustment mechanism includes an internal radial shaft that abuts with the outboard portion, an external radial shaft that surrounds the internal radial shaft and includes a shoulder and a first dovetail which is engagable with a second dovetail of the outboard portion, a nut which is threadably engaged with a boss formed on the case and with the external radial shaft whereby rotation of the nut causes engagement of the first and second dovetails to thereby adjust a radial position of the stator element and the primary clearance and adjusts a secondary clearance between the shoulder and the boss and a shim interposable between the shoulder and the boss to set the secondary clearance and in turn to set the radial position of the stator element and the primary clearance.

In accordance with additional or alternative embodiments, the radial height adjustment mechanism includes a radial shaft affixed to the outboard portion, a bridge anchored on the case and through which the radial shaft extends and a nut combination, which is threadably engaged with the radial shaft, whereby operation of the nut combination securably adjusts a radial position of the stator element relative to the bridge and the primary clearance.

According to an aspect of the disclosure, a method of adjusting a height of a stator element is provided and includes measuring a parameter between an inboard portion of the stator element and rotor elements, determining a primary clearance, with which the parameter corresponds, between the inboard portion and the rotor elements based on results of the measuring, operating a radial height adjustment mechanism, which is coupled with an outboard portion of the stator element, to adjust a radial height of the stator element and to thereby adjust the primary clearance and iteratively repeating the measuring, the determining and the operating toward the primary clearance being within predefined limits.

In accordance with additional or alternative embodiments, the parameter includes a capacitance of the inboard portion and the rotor elements across the primary clearance.

In accordance with additional or alternative embodiments, the stator element includes a body having the inboard portion at an inboard side thereof and the outboard portion at an outboard side thereof and the body includes an inner stator wall forming the inboard portion, an outer stator wall forming the outboard portion and stator vanes radially interposed between the inner stator wall and the outer stator wall.

In accordance with additional or alternative embodiments, the rotor elements include knife edges and the operating of the radial height adjustment mechanism adjusts a radial height of the stator element relative to a case of a turbine engine.

These and other advantages and features will become more apparent from the following description taken in conjunction with the drawings.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a perspective view of a stator assembly and a radial height adjustment mechanism in accordance with embodiments;

FIG. 3 is a cutaway perspective view of the stator assembly and the radial height adjustment mechanism of FIG. 2 in accordance with embodiments;

FIG. 4 is a schematic side view of a stator assembly and a radial height adjustment mechanism in accordance with embodiments;

FIG. 5 is a schematic side view of a stator assembly and a radial height adjustment mechanism in accordance with embodiments;

FIG. 6 is a schematic side view of a stator assembly and a radial height adjustment mechanism in accordance with embodiments; and

FIG. 7 is a flow diagram illustrating a method of adjusting a height of a stator element in accordance with embodiments.

These and other advantages and features will become more apparent from the following description taken in conjunction with the drawings.

### DETAILED DESCRIPTION

A detailed description of one or more embodiments of the disclosed apparatus and method are presented herein by way of exemplification and not limitation with reference to the Figures.

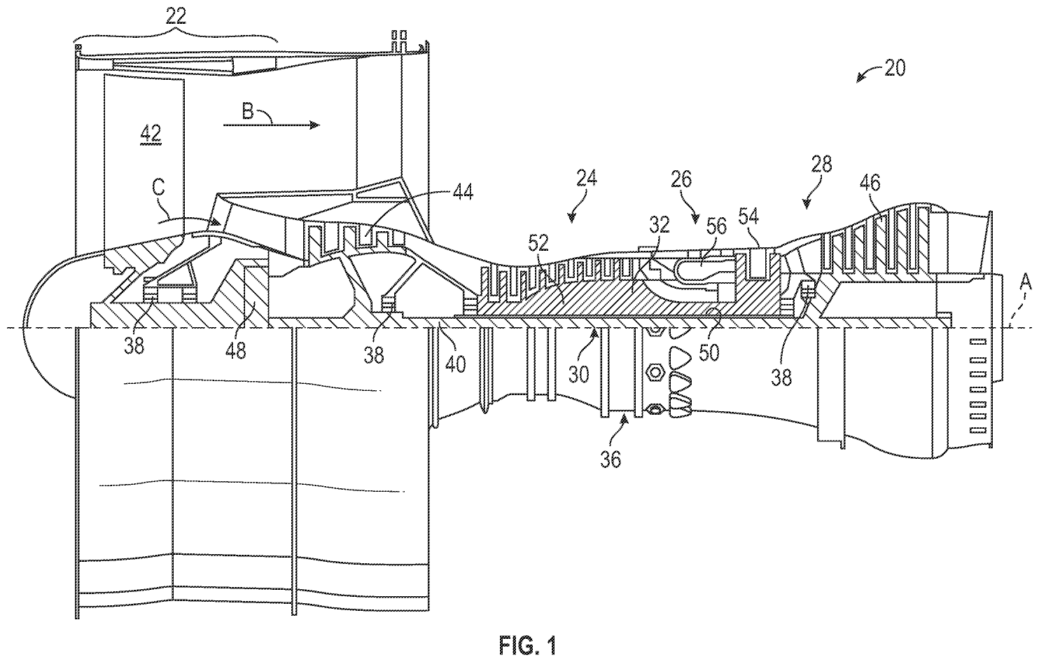

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 and then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary gas turbine engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in the gas turbine engine 20 between the high pressure compressor 52 and the high pressure turbine 54. The engine static structure 36 is arranged generally between the high pressure turbine 54 and the low pressure turbine 46. The engine static structure 36 further supports the bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 and then the high pressure compressor 52, is mixed and burned with fuel in the combustor 56 and is then expanded over the high pressure turbine 54 and the low pressure turbine 46. The high and low pressure turbines 54 and 46 rotationally drive the low speed spool 30 and the high speed spool 32, respectively, in response to the expansion. It will be appreciated that each of the positions of the fan section 22, compressor section 24, combustor section 26, turbine section 28, and fan drive gear system 48 may be varied. For example, geared architecture 48 may be located aft of the combustor section 26 or even aft of the turbine section 28, and the fan section 22 may be positioned forward or aft of the location of geared architecture 48.

As will be described below, a stator is provided with a mechanism for adjusting a radial height thereof. This allows the stator to be used at various radial locations around a case without requiring disassembly, replacement and reassembly of components.

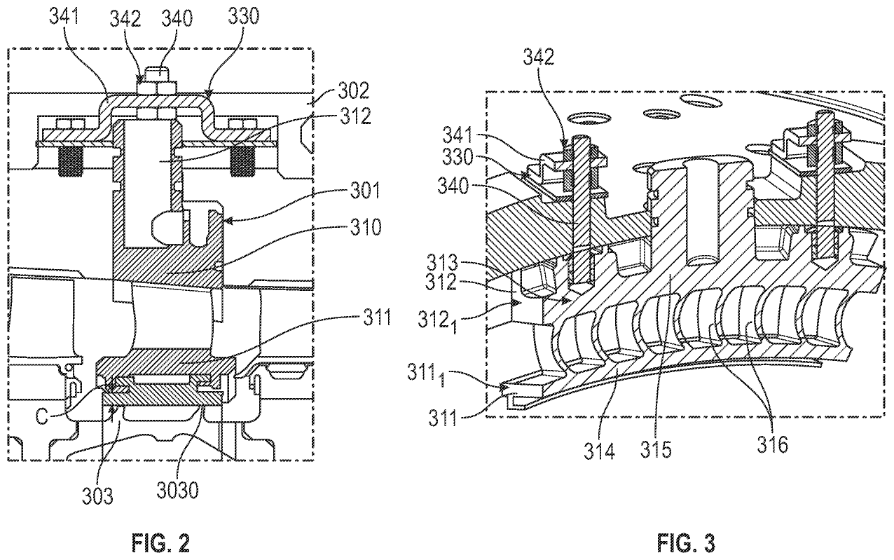

With continued reference to FIG. 1 and with additional reference to FIGS. 2 and 3, a stator assembly 301 is provided for a case 302 of a turbine engine, such as the gas turbine engine 20 of FIG. 1, which is disposed about rotor elements 303. The rotor elements 303 can be provided as knife edges 3030.

The stator assembly 301 includes a stator element 310 and a radial height adjustment mechanism 330. The stator element 310 includes an inboard portion 311 and an outboard portion 312. The inboard portion 311 establishes a primary clearance C with the rotor elements 303 and exhibits a measurable parameter corresponding to the primary clearance C. The measurable parameter can be a capacitance between the inboard portion 311 and the rotor elements 303 across the primary clearance C. The outboard portion 312 is integrally formed with the inboard portion 311 as will be discussed below such that, as a radial height or position of the outboard portion 312 is adjusted or changes, a radial height or position of the inboard portion 311 is correspondingly adjusted or changes (and thus the measurable parameter, i.e., the capacitance, is adjusted or changes). The radial height adjustment mechanism 330 is coupled with the outboard portion 312 and configured to be operable, based on the measurable parameter, to adjust a radial height of the stator element 310 relative to the case 302 and the rotor elements 303 and in turn to adjust the primary clearance C between the inboard portion 311 and the rotor elements 303.

In accordance with embodiments, the stator element 310 further includes a body 313 having the inboard portion 311 at an inboard side 3131 thereof and the outboard portion 312 at an outboard side 312₁ thereof. The body 313 can be generally rigid and includes an inner stator wall 314 forming the inboard portion 311, an outer stator wall 315 forming the outboard portion 312 and which is disposable in close proximity to an internal wall 304 of the case 302 and stator vanes 316 which are radially interposed between the inner stator wall 314 and the outer stator wall 315.

As shown in FIGS. 2 and 3 and in accordance with embodiments, the radial height adjustment mechanism 330 can include a partially threaded radial shaft 340, which is affixed to the outboard portion 312, a bridge 341 that is anchored on an exterior surface of the case 302 and through which the radial shaft 340 extends and a nut combination 342. The nut combination 342 can include a fixing nut which is abuttable with an exterior surface of the bridge 341, an adjusting nut which is adjustable to adjust a height of the radial shaft 340 and a jam nut which holds the adjustable in place in abutment with an interior surface of the bridge 341. The nut combination 342 is thus threadably engaged with the radial shaft 340 whereby operation of the nut combination 342 securably adjusts a radial position of the stator element 310 relative to the bridge 341, the case 302 and the rotor elements 303 and in turn securably adjusts the primary clearance C (see FIG. 2).

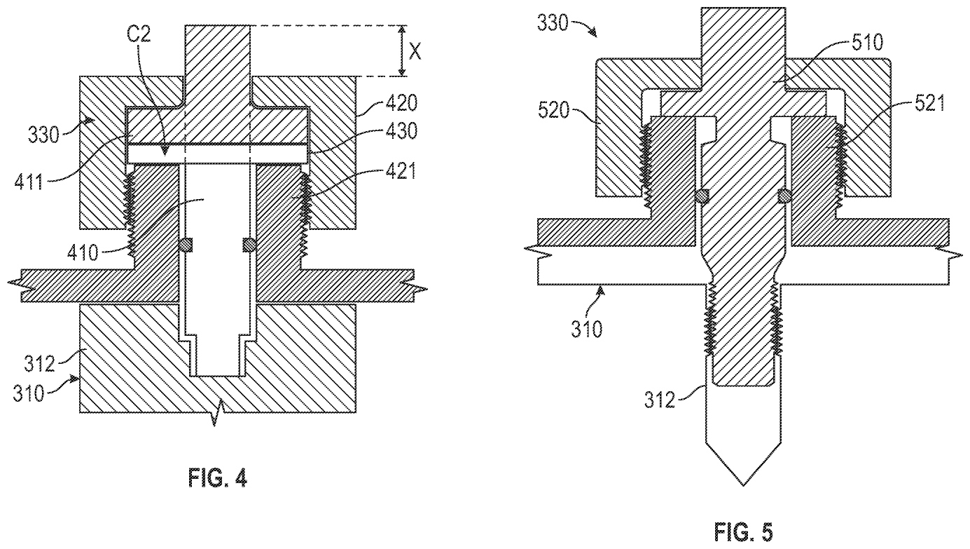

It is to be understood that the embodiments of the radial height adjustment mechanism 330 of FIGS. 2 and 3 are merely exemplary and that other embodiments exist. A selection of those embodiments will now be described with reference to FIGS. 4-6 although it is to be further understood that the various embodiments described herein is not an exhaustive list and that still other embodiments are possible. It is to be further understood that each of the embodiments described herein can be used in combination and/or interchangeably with one another and/or with any other suitable embodiments.

As shown in FIG. 4 and in accordance with embodiments, the radial height adjustment mechanism 330 can include a radial shaft 410 that is affixed to the outboard portion 312 and includes a shoulder 411, a nut 420 and a shim 430. The nut 420 is threadably engaged with a boss 421 formed on the case 302 and with the radial shaft 410. Rotation of the nut 420 adjusts a radial position of the stator element 310 relative to the case 302 and the rotor elements 303 (see FIG. 2) and the primary clearance C (see FIG. 2) and also adjusts a secondary clearance C2 between the shoulder 411 and the boss 421. The shim 430 is interposable between the shoulder 411 and the boss 421 to set the secondary clearance C2 and in turn to set the radial position of the stator element 310 and the primary clearance C.

As shown in FIG. 5 and in accordance with embodiments, the radial height adjustment mechanism 330 can include a radial shaft 510 threadably engaged with the outboard portion 312 and a nut 520. The nut 520 is threadably engaged with a boss 521 formed on the case 302 (see FIG. 2) and is affixed to the radial shaft 510. Rotation of the nut 520 rotates the radial shaft 510 and radial shaft 510 rotation securably adjusts a radial position of the stator element 510 relative to the case 302 and the rotor elements 303 and the primary clearance C.

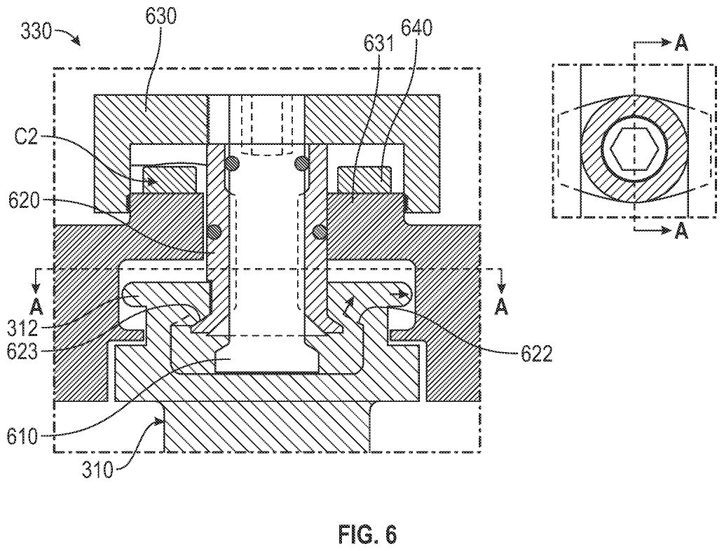

As shown in FIG. 6, the radial height adjustment mechanism 330 includes an internal radial shaft 610 that abuts with the outboard portion 312, an external radial shaft 620 that surrounds the internal radial shaft 610 and includes a shoulder 621 and a first dovetail 622. The first dovetail 622 is engagable with a second dovetail 623 of the outboard portion 312. The radial height adjustment mechanism 330 further includes a nut 630 and a shim 640. The nut 630 is threadably engaged with a boss 631 formed on the case 302 (see FIG. 2) and with the external radial shaft 620. Rotation of the nut 630 causes engagement of the first and second dovetails 622 and 623 to thereby adjust a radial position of the stator element 310 relative to the case 302 and the rotor elements 303 and the primary clearance C and adjusts a secondary clearance C2 between the shoulder 621 and the boss 631. The shim 640 is interposable between the shoulder 621 and the boss 631 to set the secondary clearance C2 and in turn to set the radial position of the stator element 310 relatively to the case 302 and the rotor elements 303 and the primary clearance C.

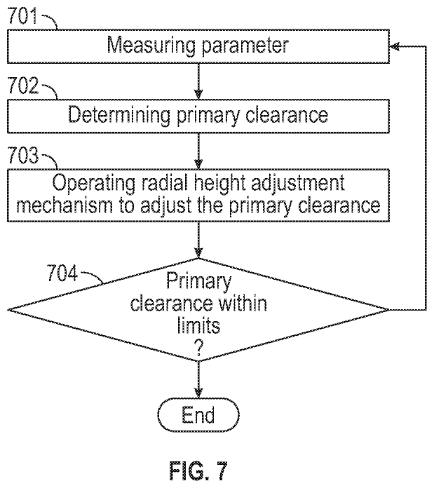

With reference to FIG. 7, a method of adjusting a height of a stator element, such as the stator element 310 described above, is provided. As shown in FIG. 7, the method includes measuring a parameter (i.e., a capacitance) between an inboard portion of the stator element and rotor elements (block 701), determining a primary clearance, with which the parameter corresponds, between the inboard portion and the rotor elements (i.e., knife edges) based on results of the measuring (block 702), operating a radial height adjustment mechanism, which is coupled with an outboard portion of the stator element, to adjust a radial height of the stator element relative to a case of a turbine engine and to thereby adjust the primary clearance (block 703) and iteratively repeating the measuring, the determining and the operating toward the primary clearance being within predefined limits (block 704).

Benefits of the features described herein are the provision of a stator with an adjustable radial height that minimizes manufacturing efforts, increases measurement confidence without measurement noise caused by disassembly and reassembly of components and minimizes potential damage to instrumentation cables, hypo tubes and egress seals.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A stator assembly, comprising:
a stator element comprising:
an inboard portion which establishes a primary clearance with rotor elements and exhibits a measurable parameter corresponding to the primary clearance; and
an outboard portion integrally formed with the inboard portion; and
a radial height adjustment mechanism coupled with the outboard portion and configured to be operable, based on the measurable parameter, to adjust a radial height of the stator element and in turn to adjust the primary clearance.

2. The stator assembly according to claim 1, wherein the measurable parameter is a capacitance.

3. The stator assembly according to claim 1, wherein the stator element further comprises a body comprising:
an inner stator wall forming the inboard portion;
an outer stator wall forming the outboard portion; and
stator vanes radially interposed between the inner stator wall and the outer stator wall.

4. The stator assembly according to claim 1, wherein the radial height adjustment mechanism comprises:
a radial shaft affixed to the outboard portion and comprising a shoulder;
a nut which is threadably engaged with the radial shaft whereby rotation of the nut adjusts a radial position of the stator element and the primary clearance and adjusts a secondary clearance; and
a shim to set the secondary clearance and in turn to set the radial position of the stator element and the primary clearance.

5. The stator assembly according to claim 1, wherein the radial height adjustment mechanism comprises:
a radial shaft threadably engaged with the outboard portion; and
a nut which is affixed to the radial shaft whereby rotation of the nut rotates the radial shaft and radial shaft rotation securably adjusts a radial position of the stator element and the primary clearance.

6. The stator assembly according to claim 1, wherein the radial height adjustment mechanism comprises:
an internal radial shaft that abuts with the outboard portion;
an external radial shaft that surrounds the internal radial shaft and comprises a shoulder and a first dovetail which is engagable with a second dovetail of the outboard portion;
a nut which is threadably engaged with the external radial shaft whereby rotation of the nut causes engagement of the first and second dovetails to thereby adjust a radial position of the stator element and the primary clearance and adjusts a secondary clearance; and
a shim to set the secondary clearance and in turn to set the radial position of the stator element and the primary clearance.

7. The stator assembly according to claim 1, wherein the radial height adjustment mechanism comprises:
a radial shaft affixed to the outboard portion;
a bridge through which the radial shaft extends; and
a nut combination, which is threadably engaged with the radial shaft, whereby operation of the nut combination securably adjusts a radial position of the stator element relative to the bridge and the primary clearance.

8. A turbine engine, comprising:
rotor elements; and
a case disposed about the rotor elements and comprising a stator assembly,
the stator assembly comprising:
a stator element comprising:
an inboard portion which establishes a primary clearance with the rotor elements and exhibits a measurable parameter corresponding to the primary clearance; and
an outboard portion integrally formed with the inboard portion; and
a radial height adjustment mechanism coupled with the outboard portion and configured to be operable, based on the measurable parameter, to adjust a radial height of the stator element and in turn to adjust the primary clearance between the inboard portion and the rotor elements.

9. The stator assembly according to claim 8, wherein the rotor elements comprise knife edges.

10. The stator assembly according to claim 8, wherein the measurable parameter is a capacitance of the inboard portion and the rotor elements across the primary clearance.

11. The stator assembly according to claim 8, wherein the stator element further comprises a body having the inboard portion at an inboard side thereof and the outboard portion at an outboard side thereof.

12. The stator assembly according to claim 11, wherein the body comprises:
an inner stator wall forming the inboard portion;
an outer stator wall forming the outboard portion and which is disposable in close proximity to an internal wall of the case; and
stator vanes radially interposed between the inner stator wall and the outer stator wall.

13. The stator assembly according to claim 8, wherein the radial height adjustment mechanism comprises:
a radial shaft affixed to the outboard portion and comprising a shoulder;
a nut which is threadably engaged with a boss formed on the case and with the radial shaft whereby rotation of the nut adjusts a radial position of the stator element and the primary clearance and adjusts a secondary clearance between the shoulder and the boss; and
a shim interposable between the shoulder and the boss to set the secondary clearance and in turn to set the radial position of the stator element and the primary clearance.

14. The stator assembly according to claim 8, wherein the radial height adjustment mechanism comprises:
a radial shaft threadably engaged with the outboard portion; and
a nut which is threadably engaged with a boss formed on the case and which is affixed to the radial shaft whereby rotation of the nut rotates the radial shaft and radial shaft rotation securably adjusts a radial position of the stator element and the primary clearance.

15. The stator assembly according to claim 8, wherein the radial height adjustment mechanism comprises:
an internal radial shaft that abuts with the outboard portion;
an external radial shaft that surrounds the internal radial shaft and comprises a shoulder and a first dovetail which is engagable with a second dovetail of the outboard portion;
a nut which is threadably engaged with a boss formed on the case and with the external radial shaft whereby rotation of the nut causes engagement of the first and second dovetails to thereby adjust a radial position of the stator element and the primary clearance and adjusts a secondary clearance between the shoulder and the boss; and
a shim interposable between the shoulder and the boss to set the secondary clearance and in turn to set the radial position of the stator element and the primary clearance.

16. The stator assembly according to claim 8, wherein the radial height adjustment mechanism comprises:
a radial shaft affixed to the outboard portion;
a bridge anchored on the case and through which the radial shaft extends; and
a nut combination, which is threadably engaged with the radial shaft, whereby operation of the nut combination securably adjusts a radial position of the stator element relative to the bridge and the primary clearance.

17. A method of adjusting a height of a stator element, the method comprising:
measuring a parameter between an inboard portion of the stator element and rotor elements;
determining a primary clearance, with which the parameter corresponds, between the inboard portion and the rotor elements based on results of the measuring;
operating a radial height adjustment mechanism, which is coupled with an outboard portion of the stator element, to adjust a radial height of the stator element and to thereby adjust the primary clearance; and
iteratively repeating the measuring, the determining and the operating toward the primary clearance being within predefined limits.

18. The method according to claim 17, wherein the parameter comprises a capacitance of the inboard portion and the rotor elements across the primary clearance.

19. The method according to claim 17, wherein the stator element comprises a body having the inboard portion at an inboard side thereof and the outboard portion at an outboard side thereof and the body comprises:
an inner stator wall forming the inboard portion;
an outer stator wall forming the outboard portion; and
stator vanes radially interposed between the inner stator wall and the outer stator wall.

20. The method according to claim 17, wherein:
the rotor elements comprise knife edges, and
the operating of the radial height adjustment mechanism adjusts a radial height of the stator element relative to a case of a turbine engine.
